(19) United States
(12) Patent Application Publication
(10) Pub. No.: US 2026/0143087 A1
(43) Pub. Date: May 21, 2026

(54) REAL-TIME GENERATION AND DISPLAY OF 4D SPATIAL VIDEO OF PARTICIPANTS IN WEB-BASED VIDEO CONFERENCES

(71) Applicant: Kenneth Lee, Fairfax, VA (US)

(72) Inventor: Kenneth Lee, Fairfax, VA (US)

(21) Appl. No.: 19/390,983

(22) Filed: Nov. 17, 2025

Related U.S. Application Data
(60) Provisional application No. 63/722,501, filed on Nov. 19, 2024.

(51) Int. Cl. H04N 7/15; G06T 13/40; G06T 17/00

(52) U.S. Cl. CPC H04N 7/157; G06T 13/40; G06T 17/00

(57) ABSTRACT

A method and system for real-time generation and display of 4D spatial video of a participant in a web-based video conference includes a headset device that captures participant video comprising a plurality of frames that depict the participant from multiple viewing angles and/or with multiple facial expressions. The headset generates a base three-dimensional (3D) model of the participant and a plurality of 3D blendshapes of the participant from first frames, each 3D blendshape comprising expression coefficients, and renders a 3D photorealistic avatar of the participant for display. The headset extracts facial expression parameters associated with the participant from subsequent frames and selects one of the 3D blendshapes using the extracted facial expression parameters. The headset modifies one or more of the expression coefficients of the selected 3D blendshape based upon the extracted facial expression parameters and updates the 3D photorealistic avatar according to the modified expression coefficients.

### RELATED APPLICATION(S)

This application claims priority to U.S. Provisional Patent Application No. 63/722,501, filed Nov. 19, 2024, the entirety of which is incorporated herein by reference.

### TECHNICAL FIELD

The subject matter of this application relates generally to methods and apparatuses, including computer program products, for real-time generation and display of four-dimensional (4D) spatial video of participants in web-based video conferences.

### BACKGROUND

Wearable headset devices—such as augmented reality (AR) devices, mixed reality (MR) devices, virtual reality (VR) devices, and other types of extended reality (XR) devices and spatial computers—have become relatively commonplace over the last several years. A notable example is the Apple® Vision Pro™ headset, which includes a lens/display component that enables a user to view digital content rendered by processing hardware in the headset while also continuing to see real world objects and surroundings. While wearing this type of device, a user can watch video content on an external display device, such as the screen of a handheld mobile device (e.g., tablet, smartphone), a television, or a computer monitor. However, in these situations, the user is simply watching regular two-dimensional (2D) video as they normally would without the headset—as can be appreciated, the headset is unnecessary, and it may be distracting or cumbersome for the user.

Current applications attempt to utilize the graphical processing unit (GPU) hardware found in many spatial computing headsets to convert a 2D video stream displayed in an application executed by the headset and/or on an external screen in a viewing area of the headset into a three-dimensional (3D) holographic video stream (such as a 3D avatar or 4D avatar that changes over time) using artificial intelligence (AI)-based technology (e.g., generative AI processing). In some cases, the 3D holographic video stream is then re-projected back into the real world, to make it appear that the 3D video is on top of the screen itself. This creates a 3D augmented reality viewing experience where the user can still interact with their surroundings (e.g., see and interact with other people and scenes) while also enjoying the personal 3D/4D viewing experience via the headset display.

One example of this is the generation of 3D avatars representing participants in web-based video conferences. Most workers participate in Zoom™ or Teams™ video conference calls multiple times a day with colleagues. Online presentations and discussions, however, are not as engaging as being in the conference room with actual people. This problem decreases engagement and leads to loss in productivity and innovation for companies. By creating 3D avatars of conference participants that are displayed to others during the call, the participants may have an increased sense of connection and engagement with the material being discussed as well as the other participants.

As can be appreciated, the above-described conversion process is resource intensive; it typically requires a large amount of computing power and processing bandwidth. Unfortunately, current commercial spatial computing headsets have limited GPU processing power and battery capacity—which prevents these headsets from being able to handle the processing needs sufficiently to perform real-time generation and display of 4D spatial video of participants in web-based video conferences.

### SUMMARY

Therefore, what is needed are improved methods and systems for generation and display of 4D spatial video of participants in web-based video conferences in real time using wearable headset devices. The techniques described herein advantageously leverage the existing hardware in such headsets to generate and display live photorealistic 4D holographic avatars based upon 2D video content in an efficient manner while also delivering a high-quality visual experience. This technology can be seamlessly integrated with any web-based conferencing platform with minimal configuration or technical effort.

As can be appreciated, the methods and systems described herein provide several technical advantages over existing systems. For example, the methods and systems enable automatic generation of live 4D photorealistic avatars for multiple participants in the same conference session. As a result, the system dynamically switches between the 4D avatars displayed to a viewer as different participants take turns speaking. In addition, the system intelligently updates the 4D avatar in real time based upon, e.g., the expression and/or viewing angle of the participant rendered as the 4D avatar. For example, if a participant's appearance changes dramatically during the conference, the system can intelligently fine-tune the appearance of the 4D avatar without significant delay using advanced generative AI models. The system can also dynamically update and store the data elements used to generate the 4D avatar (e.g., base model, blendshapes) to reflect the most current appearance of the participant in real-time, while also enabling fast retrieval of the data elements to be used in a subsequent conference call.

The invention, in one aspect, features a system for real-time generation and display of four-dimensional (4D) spatial video of a participant in a web-based video conference. The system includes a wearable headset device with one or more cameras configured to capture a front-facing field of view and one or more displays configured to present digital content to a user of the headset device. The headset device captures video of a participant in a web-based video conference, the video comprising a plurality of frames that depict the participant from multiple viewing angles and/or with multiple facial expressions. For a first one or more frames of the captured video, the headset device generates (i) a base three-dimensional (3D) model of the participant and (ii) a plurality of 3D blendshapes of the participant from the first one or more frames, each 3D blendshape comprising expression coefficients corresponding to a different facial expression, and the headset device renders a 3D photorealistic avatar of the participant for display on the headset device. For each subsequent frame of the captured video, the headset device extracts facial expression parameters associated with the participant from the subsequent frame, selects one of the 3D blendshapes of the participant using the extracted facial expression parameters, modifies one or more of the expression coefficients of the selected 3D blendshape based upon the extracted facial expression parameters, and updates the 3D photorealistic avatar of the participant displayed on the headset device according to the modified expression coefficients.

The invention, in another aspect, features a computerized method of real-time generation and display of 4D spatial video of a participant in a web-based video conference. A wearable headset device with one or more cameras configured to capture a front-facing field of view and one or more displays configured to present digital content to a user of the headset device captures video of a participant in a web-based video conference, the video comprising a plurality of frames that depict the participant from multiple viewing angles and/or with multiple facial expressions. For a first one or more frames of the captured video, the headset device generates (i) a base three-dimensional (3D) model of the participant and (ii) a plurality of 3D blendshapes of the participant from the first one or more frames, each 3D blendshape comprising expression coefficients corresponding to a different facial expression, and the headset device renders a 3D photorealistic avatar of the participant for display on the headset device. For each subsequent frame of the captured video, the headset device extracts facial expression parameters associated with the participant from the subsequent frame, selects one of the 3D blendshapes of the participant using the extracted facial expression parameters, modifies one or more of the expression coefficients of the selected 3D blendshape based upon the extracted facial expression parameters, and updates the 3D photorealistic avatar of the participant displayed on the headset device according to the modified expression coefficients.

Any of the above aspects can include one or more of the following features. In some embodiments, the headset device captures the video of the participant from a video conference application executing on the headset device. In some embodiments, the headset device captures the video of the participant from a video conference application displayed on a monitor within the front-facing field of view using the one or more cameras.

In some embodiments, the headset device generates the base 3D model of the participant and the plurality of 3D blendshapes of the participant using a trained generative AI model. In some embodiments, the headset device stores the base 3D model of the participant and the plurality of 3D blendshapes of the participant in a shared database. In some embodiments, during a subsequent web-based video conference, the headset device retrieves the base 3D model of the participant and the plurality of 3D blendshapes of the participant from the shared database without generating a new base 3D model of the participant and a new plurality of 3D blendshapes of the participant.

In some embodiments, the headset device displays the 3D photorealistic avatar of the participant in proximity to a video conference application user interface. In some embodiments, the headset device overlays the 3D photorealistic avatar of the participant on top of a video conference application user interface. In some embodiments, the 3D photorealistic avatar of the participant is a life size representation of the participant.

In some embodiments, the participant in the web-based video conference corresponds to a person that is currently speaking. In some embodiments, when the facial expression of the participant changes during the web-based video conference, the facial expression of the 3D photorealistic avatar of the participant is synchronized to a current facial expression of the participant. In some embodiments, when the viewing angle of the participant changes during the web-based video conference, the viewing angle of the 3D photorealistic avatar of the participant is synchronized to a current viewing angle of the participant.

In some embodiments, the expression coefficients relate to one or more of a shape of the participant's mouth and a shape of the participant's eyes. In some embodiments, the headset device selects one of the 3D blendshapes of the participant by comparing the extracted facial expression parameters to the expression coefficients of each 3D blendshape of the participant and selecting the 3D blendshape of the participant with expression coefficients that most closely match the extracted facial expression parameters.

Other aspects and advantages of the technology will become apparent from the following detailed description, taken in conjunction with the accompanying drawings, illustrating the principles of the technology by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for real-time generation and display of four-dimensional (4D) spatial video of a participant in a web-based video conference.

FIG. 2 is a flow diagram of a computerized method of real-time generation and display of 4D spatial video of a participant in a web-based video conference.

FIG. 3 is a diagram of an exemplary video conference application user interface that can be presented to a user of a wearable headset device.

FIG. 4 is a diagram of exemplary video frames captured by a wearable headset device that depict a participant with multiple different expressions or from multiple different viewing angles.

FIG. 5 is a diagram of a video conference user interface that displays a 4D photorealistic avatar of a video conference participant.

### DETAILED DESCRIPTION

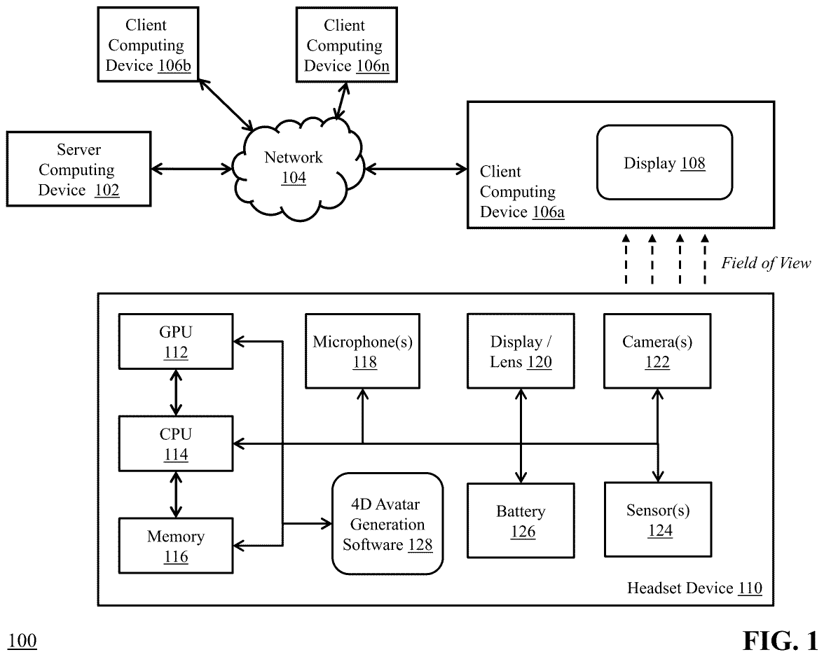

FIG. 1 is a block diagram of system 100 for real-time generation and display of four-dimensional (4D) spatial video of a participant in a web-based video conference. System 100 includes server computing device 102 coupled to a communications network 104 that connects server computing device 102 to a plurality of client computing devices 106a-106n. Client computing device 106 includes display device 108 (e.g., a screen for viewing 2D video).

Server computing device 102 is a combination of hardware and software modules that includes specialized hardware and/or software modules that execute on one or more processors and interact with memory modules of server computing device 102 to transmit video content (e.g., web-based video conference participant stream(s)) to client computing devices 106a-106n via network 104. In some embodiments, server computing device 102 is part of a video conferencing platform that establishes and coordinates a live video conference session between client computing devices 106a-106n, including receiving participant video streams from each client device and transmitting the participant video streams to other participants in the video conference for display on the respective client computing devices 106a-106n. Exemplary video conference platforms include, but are not limited to, Zoom™, Microsoft® Teams™, and Cisco® WebEx™. It should be appreciated that server computing device 102 can be implemented as any number of computing devices, arranged in a variety of architectures, resources, and configurations (e.g., cluster computing, virtual computing, cloud computing) without departing from the scope of the technology described herein.

Network 104 enables the other components of system 100 to communicate with each other in order to perform functions relating to the process of real-time generation and display of four-dimensional (4D) spatial video of a participant in a web-based video conference as described herein. Network 104 may be a local network, such as a LAN, or a wide area network, such as the Internet and/or a cellular network. In some embodiments, network 104 is comprised of several discrete networks and/or sub-networks (e.g., cellular to Internet) that enable the components of the system of FIG. 1 to communicate with each other.

Client computing devices 106a-106n use software and circuitry (e.g., one or more processors and memory modules) to execute applications and communicate with server computing device 102 via communications network 104. In some embodiments, client computing devices 106a-106n receive video content (e.g., participant video streams generated by other client devices) from server computing device 102 and display the video content on a display screen of the device (e.g., display 108 of client computing device 106a). In some embodiments, client computing devices 106a-106n capture video content (e.g., video stream of the participant using the client device) using a camera coupled to the client device and transmit the captured video content to server computing device 102 for inclusion in the video conference stream that is transmitted to each of the participants. Exemplary client computing devices 106a-106n include, but are not limited to, tablets (e.g., Apple® iPad®), smartphones (e.g., Apple® iPhone®), desktop computers, laptop computers, and smart televisions. It should be appreciated that other types of computing devices that are capable of connecting to the components of system 100 of FIG. 1 can be used without departing from the scope of the technology described herein.

System 100 also comprises headset device 110, which includes a combination of specialized hardware and/or software modules that execute programmatic instructions to receive data, process data, display data, and transmit data, and to communicate with other devices of system 100 in order to perform functions for real-time generation and display of four-dimensional (4D) spatial video of a participant in a web-based video conference as described herein. Headset device 110 includes graphics processing unit (GPU) hardware 112, central processing unit (CPU) hardware 114, memory 116 (e.g., solid state RAM), one or more microphones 118, a display/lens apparatus 120 (e.g., one or more micro-OLED displays that can adjustably display digital content while also enabling a wearer to see real-world surroundings), one or more cameras 122), one or more sensors 124 (e.g., accelerometers, gyroscopes, iris trackers), battery 126, and 4D avatar generation software 128. Exemplary headset devices 110 include, but are not limited to, the Apple® Vision Pro™ headset. In some embodiments, although not shown in FIG. 1, headset device 110 also includes one or more speakers to produce audio content for the wearer and networking hardware (e.g., Bluetooth™, Wi-Fi™) to enable headset device 110 to wirelessly connect to client computing device 106a and/or network 104. In some embodiments, 4D avatar generation module 128 is one or more specialized sets of computer software instructions programmed onto a processor (e.g., GPU 112, CPU 114) in headset device 110 and can include designated memory locations and/or registers for executing the specialized computer software instructions.

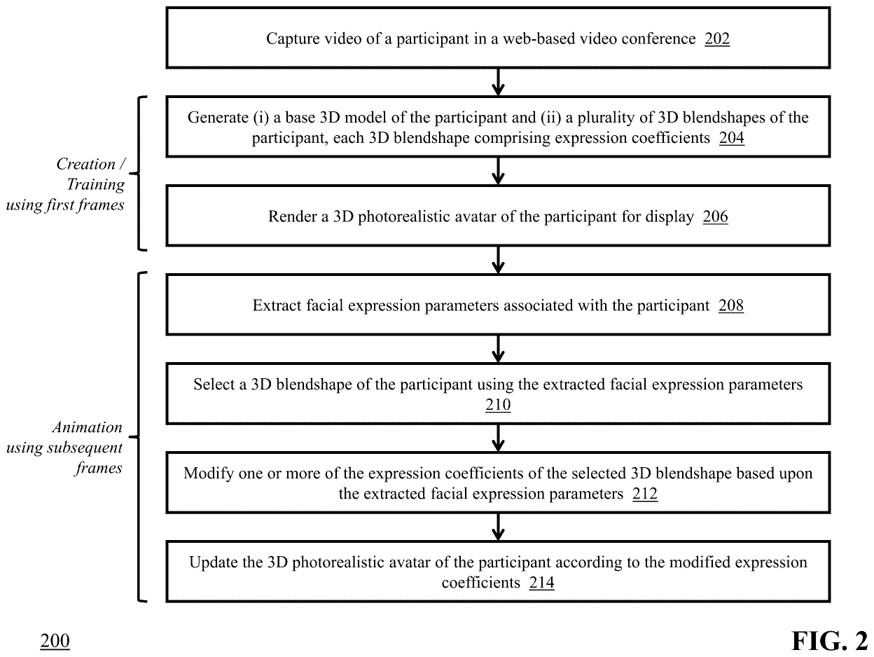

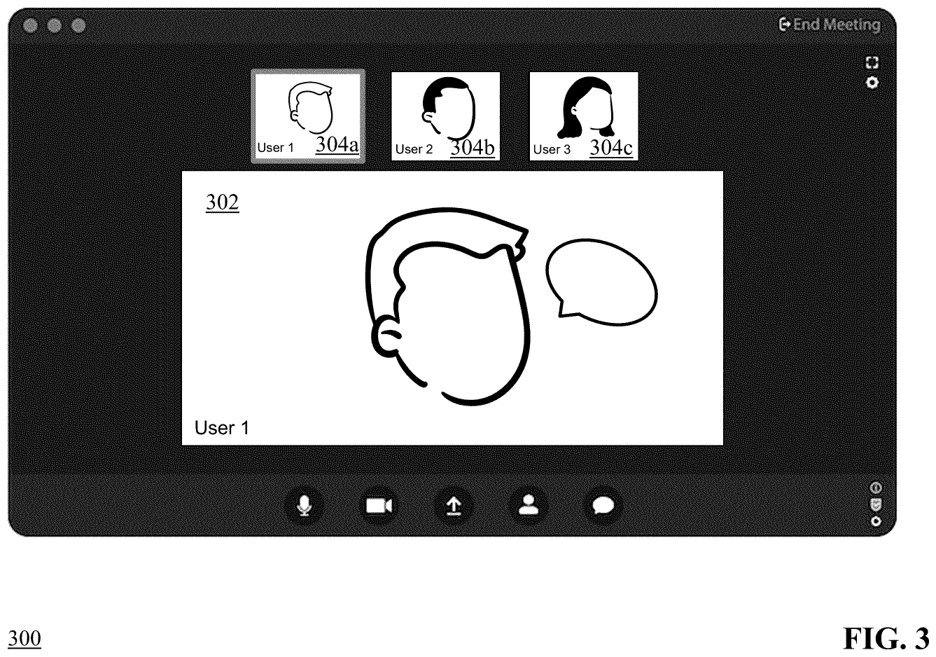

FIG. 2 is a flow diagram of a computerized method 200 of real-time generation and display of 4D spatial video of a participant in a web-based video conference, using system 100 of FIG. 1. In some embodiments, a user is wearing headset device 110 while also viewing video content on display screen 108 of client computing device 106. In other embodiments, the user is viewing video content generated by headset device 110 for presentation to the user via display/lens 120. For example, the video content can be a web-based video conference that depicts video streams of one or more participants. FIG. 3 is a diagram of an exemplary video conference application user interface 300 that can be presented to a user via display screen 108 of client computing device 106a and/or display/lens of headset device 100. As shown in FIG. 3, user interface 300 includes a main video viewing area 302 and a plurality of participant video stream areas 304a-304c. In this example, a video stream of each participant in the video conference is captured by the respective client computing devices 106a-106n for display in one of the areas 304a-304c, so that all participants in the conference can see each other. In addition, the main video viewing area 302 is configured to display the video stream of the participant that is currently speaking (as illustrated by the chat bubble in area 302). In some embodiments, the video conference application is configured to highlight the specific participant video stream that corresponds to the current speaker—in this case, because User 1 is speaking, the corresponding participant video stream area 304a is highlighted with a gray border. As can be appreciated, when User 1 stops speaking and User 2 starts speaking, the user interface 300 is updated so that the video stream of User 2 is displayed in main area 302 and the participant video stream area 304b of User 2 is highlighted.

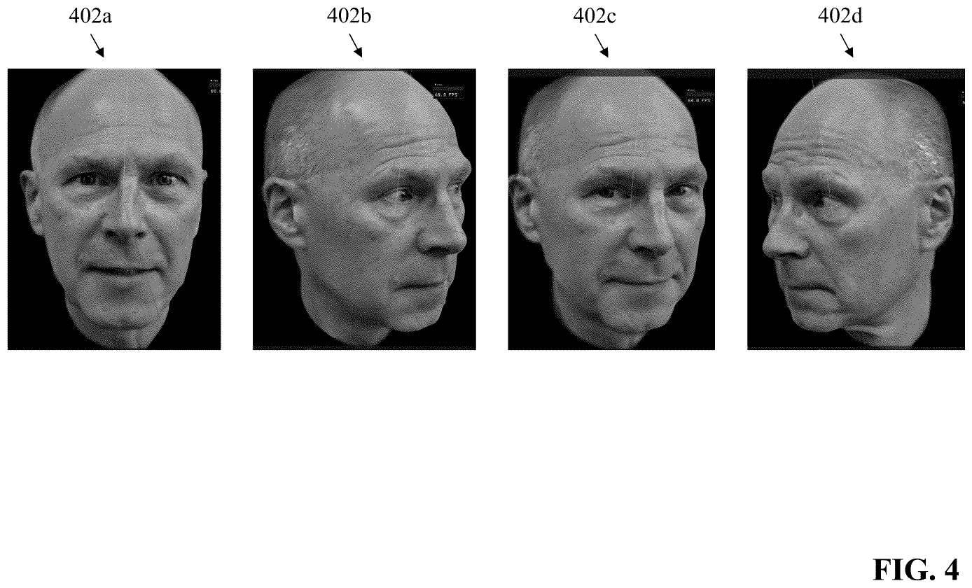

Turning back to FIGS. 2, 4D avatar generation software 128 of headset device 110 captures (step 202) video of one or more participants in the web-based video conference. In some embodiments, the captured video comprises a plurality of frames that depict the participant from multiple viewing angles and/or with multiple facial expressions. For example, as the video conference begins, software 128 can capture video of a participant (e.g., the current speaker)—either by capturing the video directly from the video conference application executing on the headset device, or by capturing the video using one or more cameras 122 of headset device that are viewing a display screen (e.g., display 108) of another computing device (e.g., client computing device 106a) that is presenting the web-based video conference user interface. Typically, the participant will exhibit a range of different facial expressions and/or carry out a range of different head movements (which result in other participants seeing the speaker's face from different viewing angles) as they are speaking. Software 128 captures video frames associated with each of the different facial expressions and/or face viewing angles. In some embodiments, software 128 can preprocess the captured video frames to select one or more frames that correspond to each different facial expression and/or viewing angle (e.g., by eliminating duplicate frames). FIG. 4 is a diagram of exemplary video frames 402a-402d captured by headset device that depict a participant with multiple different expressions and/or from multiple different viewing angles.

While the video frames 402a-402d in FIG. 4 just show the participant's head, it should be appreciated that the methods and systems described herein are not limited to tracking and rendering only the head or face of a participant. In some embodiments, system 100 can be configured to track a participant's face/head/torso/arms or even a participant's entire body, using the same model training and animation techniques as described herein with respect to the head and face.

4D avatar generation software 128 initiates a process to generate and display 4D spatial video of one or more participants in the web-based video conference. As shown in FIG. 2, the process comprises two phases: a creation/training phase using a first set of one or more frames from the captured video and an animation phase using video frames of the participant that are captured after the creation/training phase.

4D avatar generation software 128 generates (i) a base 3D model of the participant and (ii) a plurality of 3D blendshapes of the participant. In some embodiments, software 128 generates the base 3D model of the participant using a 3D template model (e.g., a head model). In some embodiments, software 128 uses the first one or more captured video frames to learn a neutral model (i.e., an expressionless model) of the participant's head. Each 3D blendshape corresponds to a different facial expression and therefore each 3D blendshape comprises expression coefficients corresponding to the different facial expression (i.e., the facial expression exhibited by the participant in the associated frame(s)). In some embodiments, the process for generating the base 3D model and 3D blendshapes involves training a generative AI model that takes the two-dimensional (2D) images and shapes the 3D template to minimize any loss between the reprojected 3D template back to the 2D image versus the image from the actual video. As a result, software 128 generates a finite number of 3D blendshapes to represent most facial expressions of the participant. In addition, software 128 employs certain finite trained parameters (e.g., parameter(s) that control the eyes, parameter(s) that control the mouth, etc.) that are needed to select the correct 3D blendshape and fine-tune the expression during the animation phase. An exemplary algorithm and process that can be used by software 128 to generate the base 3D model and the plurality of 3D blendshapes is described in S. Ma et al., “3D Gaussian Blendshapes for Head Avatar Animation,” SIGGRAPH Conference Papers '24, Jul. 27-Aug. 1, 2024, Denver, CO, USA (2024), arXiv:2404.19398v2 [cs.GR], May 2, 2024, available at arxiv.org, which is incorporated by reference herein. Software 128 then renders (step 206) a 3D photorealistic avatar of the participant based upon the base 3D model and the plurality of 3D blendshapes.

It should be appreciated that in some embodiments the creation/training phase can be performed by headset device 110 as described herein. In some embodiments, the creation/training phase can be performed by another computing device, such as a server computing device that receives captured video frames and generates a base 3D model and 3D blendshapes for a participant and stores the 3D model and blendshapes in a repository. In these embodiments, the pre-generated 3D model and blendshapes can be downloaded to headset device 110 prior to or during a video conference involving the participant.

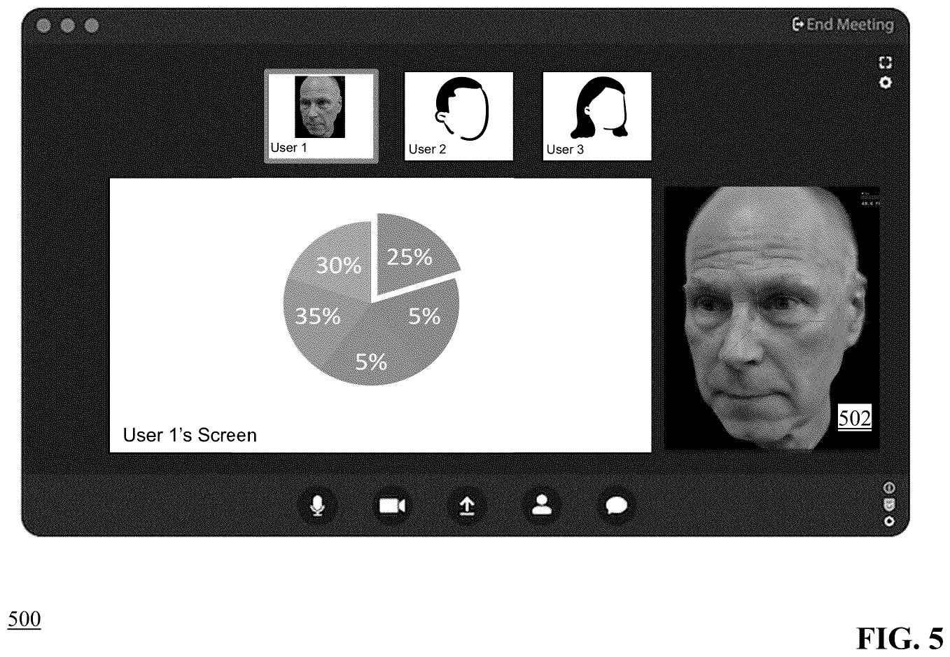

Software 128 displays the 3D photorealistic avatar to a user of the headset device 110 via, e.g., display/lens 120. FIG. 5 is a diagram of a video conference user interface 500 that displays a 4D photorealistic avatar 502 of a video conference participant, as generated by software 128 of headset device 110 during the web-based video conference. As shown in FIG. 5, user interface 500 displays the 4D photorealistic avatar 502 in proximity to the main viewing area 504 of the interface. In this example, User 1 is currently speaking and also sharing his screen in the main viewing area as part of a presentation. Software 128 renders the 4D photorealistic avatar to the user of headset device 110 so the user has the impression of being in the same room as the speaker. In some embodiments, the 4D photorealistic avatar 502 appears life-size to the user of headset device 110. Generally, the 4D photorealistic avatar 502 can be placed in the user's field of view by headset device 110 such that the avatar appears anywhere in the user's room—the avatar does not need to be placed next to or near the screen. In some embodiments, software 128 can overlay the 4D avatar onto, e.g., the main viewing area and/or the participant video stream area of the video conference user interface 500.

In some embodiments, software 128 is configured to store the base 3D model and the 3D blendshapes (including the expression coefficients) corresponding to one or more participants generated during the training phase for later use. For example, software 128 can store the base 3D model and the 3D blendshapes in local memory 116 of the headset device 110. In another example, software 128 can store the base 3D model and the 3D blendshapes in a database coupled to server computing device 102. Advantageously, upon initiation of a later video conference involving the same participant(s), software 128 can retrieve the stored base 3D model and 3D blendshapes instead of executing a new training phase to generate the base 3D model and 3D blendshapes again. For example, headset device 110 can capture the participant details from the video conference software platform during establishment of the video conference and retrieve the stored 3D model and blendshapes for each participant using, e.g., an identifier or name (such as display name or user handle) associated with each participant.

In some embodiments, the stored base 3D model and 3D blendshapes may differ in one or more visual characteristics or appearance features from the one or more frames of the participant that are captured during a current video conference. For example, the participant may have been wearing different clothes in the prior conference that are reflected in the stored 3D model and blendshapes. In other examples, the participant may have grown (or shaved off) facial hair, the participant may now be wearing glasses, etc. In any of these scenarios, software 128 can automatically update the stored base 3D model and 3D blendshapes using the newly captured frames to include the changed appearance features. It should be appreciated, that in some cases, users may experience a brief amount of latency upon initiating the video conference before the photorealistic avatar of a participant has been updated to reflect the current appearance features of the participant.

It should be appreciated that 4D avatar generation software 128 can be configured to perform steps 204 and 206 described above for each of a plurality of participants during a single web-based video conference—thereby generating a base 3D model and a plurality of 3D blendshapes for each participant that can be used to display a photorealistic avatar of each participant and that dynamically changes during the animation phase to reflect the participant's expressions and movements in real time. In addition, as the participants take turns speaking during the video conference, software 128 automatically switches the photorealistic avatar that is displayed to the user of headset device 110 to match the current speaker. In some embodiments, software 128 is configured to display a plurality of photorealistic 3D avatars to the user of headset device 110 that represent multiple different participants in the video conference.

Turning back to FIG. 2, now that the photorealistic 3D avatar has been generated for the participant, 4D avatar generation software 128 proceeds to the animation phase where subsequent captured video frames for the participant are used to dynamically update the 3D avatar to be synchronized to the expression(s) and/or movement(s) of the actual participant.

For each of one or more subsequent video frames of the participant, software 128 extracts (step 208) facial expression parameters associated with the participant. As mentioned above, software 128 can be configured to extract the facial expression parameters from the subsequent frame using the trained generative AI model. Generally, a primary task of software 128 is to select the right blendshape or combination of blendshapes (e.g., one blendshape for the overall head/face and a separate blendshape for only the mouth area). In this example, each facial expression parameter controls a part of the face to finetune the expressions of the model. For example, one of the facial expression parameters may control movements around the mouth, another facial expression may control movements around the eyes, and so forth. As can be appreciated, there may be many different facial expression parameters available for manipulation depending upon a desired granularity of movements for the model.

4D avatar generation software 128 then selects (step 210) a 3D blendshape of the participant (as previously generated by software 128 during the training phase) using the extracted facial expression parameters. In some embodiments, software 128 compares one or more of the extracted facial expression parameters to one or more corresponding expression coefficients of each of the 3D blendshapes to determine which 3D blendshape to select. For example, software 128 can select one of the 3D blendshapes with coefficients that most closely match the expression parameters extracted from the subsequent frame(s)—meaning that the expression exhibited by the participant in the blendshape is the most similar to the expression exhibited by the participant in the subsequent frame. A benefit of this is that software 128 is able to deploy smaller change(s) to the expression coefficients of the 3D blendshape when modifying the 4D avatar to match the current expression of the speaker. In some embodiments, software 128 uses a similarity measure or tolerance value when determining which 3D blendshape coefficients most closely matches the extracted expression parameters.

Once 4D avatar generation software 128 has selected the 3D blendshape, software 128 modifies (step 212) one or more of the expression coefficients of the selected 3D blendshape based upon the facial expression parameters extracted from the subsequent frame. In some embodiments, software 128 determines a differential between (i) a value of one of the expression coefficients of the selected 3D blendshape and (ii) a value of a corresponding expression parameter extracted from the frame. Then, software 128 adjusts the value of the expression coefficient to match the value of the expression parameter—resulting in an expression match to the current expression of the participant.

When the 3D blendshape expression coefficients have been modified, software 128 updates (step 214) the 3D photorealistic avatar of the participant displayed to the user of the headset device 110 according to the modified expression coefficients. In some embodiments, software 128 applies the modified 3D blendshape to the 3D photorealistic avatar to render an updated avatar with an expression that matches the current expression of the participant.

In addition to the above, the technology is applicable to any application that can benefit from more real-time immersive engagement.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the technology described herein by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting the subject matter described herein.

What is claimed is:

1. A system for real-time generation and display of four-dimensional (4D) spatial video of a participant in a web-based video conference, the system comprising:
a wearable headset device including: one or more cameras configured to capture a front-facing field of view, and one or more displays configured to present digital content to a user of the headset device,
the headset device configured to:
capture video of a participant in a web-based video conference, the video comprising a plurality of frames that depict the participant from multiple viewing angles and/or with multiple facial expressions;
for a first one or more frames of the captured video:
generate (i) a base three-dimensional (3D) model of the participant and (ii) a plurality of 3D blendshapes of the participant from the first one or more frames, each 3D blendshape comprising expression coefficients corresponding to a different facial expression, and
render a 3D photorealistic avatar of the participant for display on the headset device;
for each subsequent frame of the captured video:
extract facial expression parameters associated with the participant from the subsequent frame,
select one of the 3D blendshapes of the participant using the extracted facial expression parameters,
modify one or more of the expression coefficients of the selected 3D blendshape based upon the extracted facial expression parameters, and
update the 3D photorealistic avatar of the participant displayed on the headset device according to the modified expression coefficients.

2. The system of claim 1, wherein the headset device captures the video of the participant from a video conference application executing on the headset device.

3. The system of claim 1, wherein the headset device captures the video of the participant from a video conference application displayed on a monitor within the front-facing field of view using the one or more cameras.

4. The system of claim 1, wherein the headset device generates the base 3D model of the participant and the plurality of 3D blendshapes of the participant using a trained generative AI model.

5. The system of claim 4, wherein the headset device stores the base 3D model of the participant and the plurality of 3D blendshapes of the participant in a shared database.

6. The system of claim 5, wherein during a subsequent web-based video conference, the headset device retrieves the base 3D model of the participant and the plurality of 3D blendshapes of the participant from the shared database without generating a new base 3D model of the participant and a new plurality of 3D blendshapes of the participant.

7. The system of claim 1, wherein the headset device displays the 3D photorealistic avatar of the participant in proximity to a video conference application user interface.

8. The system of claim 7, wherein the headset device overlays the 3D photorealistic avatar of the participant on top of a video conference application user interface.

9. The system of claim 7, wherein the 3D photorealistic avatar of the participant is a life size representation of the participant.

10. The system of claim 1, wherein the participant in the web-based video conference corresponds to a person that is currently speaking.

11. The system of claim 10, wherein when the facial expression of the participant changes during the web-based video conference, the facial expression of the 3D photorealistic avatar of the participant is synchronized to a current facial expression of the participant.

12. The system of claim 10, wherein when the viewing angle of the participant changes during the web-based video conference, the viewing angle of the 3D photorealistic avatar of the participant is synchronized to a current viewing angle of the participant.

13. The system of claim 1, wherein the expression coefficients relate to one or more of a shape of the participant's mouth and a shape of the participant's eyes.

14. The system of claim 1, wherein the headset device selects one of the 3D blendshapes of the participant by comparing the extracted facial expression parameters to the expression coefficients of each 3D blendshape of the participant and selecting the 3D blendshape of the participant with expression coefficients that most closely match the extracted facial expression parameters.

15. A computerized method of real-time generation and display of four-dimensional (4D) spatial video of a participant in a web-based video conference, the method comprising:
capturing, by a wearable headset device, video of a participant in a web-based video conference, the video comprising a plurality of frames that depict the participant from multiple viewing angles and/or with multiple facial expressions;
for a first one or more frames of the captured video:
generating, by the headset device, (i) a base three-dimensional (3D) model of the participant and (ii) a plurality of 3D blendshapes of the participant from the first one or more frames, each 3D blendshape comprising expression coefficients corresponding to a different facial expression, and
rendering, by the headset device, a 3D photorealistic avatar of the participant for display to a user of the headset device;
for each subsequent frame of the captured video:
extracting, by the headset device, facial expression parameters associated with the participant from the subsequent frame,
selecting, by the headset device, one of the 3D blendshapes of the participant using the extracted facial expression parameters,
modifying, by the headset device, one or more of the expression coefficients of the selected 3D blendshape based upon the extracted facial expression parameters, and
updating, by the headset device, the 3D photorealistic avatar of the participant displayed on the headset device according to the modified expression coefficients.

16. The method of claim 15, wherein the headset device captures the video of the participant from a video conference application executing on the headset device.

17. The method of claim 15, wherein the headset device captures the video of the participant from a video conference application displayed on a monitor within a front-facing field of view using one or more cameras coupled to the headset device.

18. The method of claim 15, wherein the headset device generates the base 3D model of the participant and the plurality of 3D blendshapes of the participant using a trained generative AI model.

19. The method of claim 15, wherein the headset device stores the base 3D model of the participant and the plurality of 3D blendshapes of the participant in a shared database.

20. The method of claim 19, wherein during a subsequent web-based video conference, the headset device retrieves the base 3D model of the participant and the plurality of 3D blendshapes of the participant from the shared database without generating a new base 3D model of the participant and a new plurality of 3D blendshapes of the participant.

21. The method of claim 15, further comprising displaying, by the headset device, the 3D photorealistic avatar of the participant in proximity to a video conference application user interface.

22. The method of claim 21, wherein the headset device overlays the 3D photorealistic avatar of the participant on top of a video conference application user interface.

23. The method of claim 21, wherein the 3D photorealistic avatar of the participant is a life size representation of the participant.

24. The method of claim 15, wherein the participant in the web-based video conference corresponds to a person that is currently speaking.

25. The method of claim 24, wherein when the facial expression of the participant changes during the web-based video conference, the facial expression of the 3D photorealistic avatar of the participant is synchronized to a current facial expression of the participant.

26. The method of claim 24, wherein when the viewing angle of the participant changes during the web-based video conference, the viewing angle of the 3D photorealistic avatar of the participant is synchronized to a current viewing angle of the participant.

27. The method of claim 15, wherein the expression coefficients relate to one or more of a shape of the participant's mouth and a shape of the participant's eyes.

28. The method of claim 15, wherein the headset device selects one of the 3D blendshapes of the participant by comparing the extracted facial expression parameters to the expression coefficients of each 3D blendshape of the participant and selecting the 3D blendshape of the participant with expression coefficients that most closely match the extracted facial expression parameters.
